(19) United States
(12) Patent Application Publication
(10) Pub. No.: US 2012/0188245 A1
(43) Pub. Date: Jul. 26, 2012

(54) DISPLAY RESOLUTION INCREASE WITH MECHANICAL ACTUATION

(75) Inventor: Edward Craig Hyatt, Cupertino, CA (US)

(73) Assignee: Apple Inc., Cupertino, CA (US)

(21) Appl. No.: 13/010,692

(22) Filed: Jan. 20, 2011

(51) Int. Cl. G06T 17/00; G09G 5/39

(52) U.S. Cl. 345/428; 345/531

(57) ABSTRACT

There are provided apparatuses and methods for increasing the pixel density of a digital display through mechanical actuation. In some embodiments, a display device is described having a processor configured to provide an image for display and a memory coupled to the processor. The memory stores the image and is configured to map the image to a pixel matrix. A display controller is coupled to the memory and configured to sample portions of the image and to store the portions of the image into planes. Each sampled portion comprises a different set of pixels of the pixel matrix. A display is coupled to the display controller and is configured to display the contents of the sampled planes. In particular, the display controller is configured to sequentially provide the sampled planes to the display for sequential display. At least one actuator is coupled to the display to displace the display for the displaying of the sampled planes, so that pixels of each plane are displayed in a unique location from the pixels of other planes.

### BACKGROUND

1. Technical Field

The present disclosure relates to display systems and, more particularly, to increasing a resolution of a display through mechanical actuation.

2. Background

Pixels are generally considered the smallest addressable unit in a display that are used to generate an image. The characteristics of individual pixels may result from a combination of factors. For the purposes of this disclosure, the color of each pixel may be generated by combinations of red, green, and blue luminous elements. The red, green and blue luminous elements, taken together, may be referred to as a “physical pixel.”

Colloquially, the “resolution” of a display refers to the number of pixels utilized in the display. The resolution of a particular display has become a common benchmark for displays, particularly since the advent of high definition consumer displays. For example, the 720p and 1080i/p standards refer to 1280×720 pixels and 1920×1080 pixels, respectively. Pixel density is related to resolution. Pixel density refers to the number of pixels per unit length. Higher density displays typically are capable of producing finer details in displayed images than lower density displays. Higher pixel density may incur significant costs. In particular, there may be additional cost to manufacture smaller pixel sizes to enable higher density. Additionally, a greater amount of processing power may be required and increased power consumption may be incurred by operation of a high density display relative to lower density display.

These factors may take greater consideration in portable displays devices where batteries provide the power and space/weight may be limited. In particular, a portable heads-up display may be size and weight constrained such that addition of physical pixels may not be practical. Conventionally, fewer physical pixels may mean lower cost to manufacture, lower weight, smaller size, but also lower resolution.

### SUMMARY

There are provided apparatuses and methods for increasing the pixel density of a digital display through mechanical actuation. Generally, the pixel density of a display is increased by dividing and storing images into separate planes, the contents of which are sequentially provided to a display. For example, the contents of a first plane are displayed and then the contents of a second plane are displayed, and so forth. All of planes' content for a particular image are displayed within a single refresh frame. Additionally, for display of the contents of each plane, the display is displaced so that the contents of each plane are displayed in a unique location relative to the other planes. Hence, all of the content of the original image is displayed within a single refresh frame and the display appears to have a pixel density greater than that of the physical pixels of the display.

In some embodiments, a display device is described having a processor configured to provide an image for display and a memory coupled to the processor. The memory stores the image and is configured to map the image to a pixel matrix. A display controller is coupled to the memory and configured to sample portions of the image and to store the portions of the image into planes. Each sampled portion comprises a different set of pixels of the pixel matrix. A display is coupled to the display controller and is configured to display the contents of the sampled planes. In particular, the display controller is configured to sequentially provide the sampled planes to the display for sequential display. At least one actuator is coupled to the display to displace the display for the displaying of the sampled planes, so that pixels of each plane are displayed in a unique location from the pixels of other planes.

In some embodiments, a method of increasing resolution through mechanical actuation is provided. The method may include sending an image to a memory buffer and mapping the image to a pixel matrix. The pixel matrix may be divided into multiple planes with each plane having a different set of pixels of the image. The planes may be sequentially displayed with their respective set of pixels and the display may be shifted with an actuator so that pixels of each plane display in a unique location.

In some embodiments, a display device is provided having a processor configured to read in an image having a first resolution. A memory buffer is coupled to the processor and configured to receive the image. A display controller is coupled to the memory buffer and configured to sample a first portion of the image and save the first portion of the image into a first plane. Additionally, the display controlled is configured to sample a second portion of the image and save the second portion of the image into a second plane. The first portion and the second portion include different portions of the image. A display is coupled to the display controller. The display includes a number of physical pixels which corresponds to a number of pixels in the first and second portions of the image. An actuator is coupled to the display and the display is configured to sequentially display the pixels of the first plane and the second plane and the actuator is configured to displace the display after display of the pixels of the first plane so that the pixels of the second plane are displayed in a second position.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates an example display device.

FIG. 2 is a cross sectional view of the display device of FIG. 1 taken along line AA.

FIG. 3 is a block diagram of a display device.

FIG. 4 illustrates an image having a portion of the image expanded to show a physical pixel.

FIG. 5 illustrates a portion of an image mapped to pixels and divided between two planes.

FIG. 6 illustrates the portion of an image mapped to pixels and divided between four planes.

FIG. 7 illustrates the portion of an image and the shifting of physical pixels to display four pixels, each in a unique location.

FIG. 8 illustrates shifting of a lens to displace the position of a displayed pixel.

FIG. 9 illustrates a low resolution display.

FIG. 10 illustrates a lens array that may overlay the low resolution display of FIG. 9.

FIG. 11 illustrates displayed pixels in four locations with corresponding shift of lenses in the lens array of FIG. 10.

FIG. 12 illustrates a high resolution output having an apparent pixel density four times greater than the physical pixel density of the low resolution display of FIG. 9.

FIG. 13 illustrates a pixel being reflected off a mirror for display in a first position.

FIG. 14 illustrates display the pixel in a different position due to displacement of the mirror of FIG. 13.

FIG. 15 is a flow chart illustrating a method for increasing resolution with mechanical actuation.

### DETAILED DESCRIPTION

A display device is described herein that provides for increased resolution without increasing the number of physical pixels. In particular, an actuator is implemented to shift physical pixels between multiple positions within a prescribed time period so that a single physical pixel appears to a viewer as multiple pixels. Hence, the pixel density is effectively multiplied by the number of positions to which the physical pixels may be displayed.

In some embodiments, a display controller may be implemented to control the actuators and the display of pixels. The display controller may divide pixels of an original image into conceptual planes based on the number of positions to which the physical pixels may be displaced. For example, if the physical pixels may be displaced from a first position to a second position, the display controller may divide the pixels of an image between two conceptual planes with every other sequential pixel, every other row of pixels or every other column of pixels going to the second plane. Each conceptual plane of pixels may be displayed for a portion of an image refresh cycle. That is, pixels from the first conceptual plane may be displayed for a first portion of the image refresh cycle at a first location and pixels from the second conceptual plane may be displayed for a second portion of the image refresh cycle at a second location. Because all of the pixels from the original image are displayed within a refresh cycle, the original image appears to a viewer. Thus, although a display device may be limited in the number of physical pixels available, through shifting of the physical pixels and displaying another set of pixels, the pixel density appears to have increased.

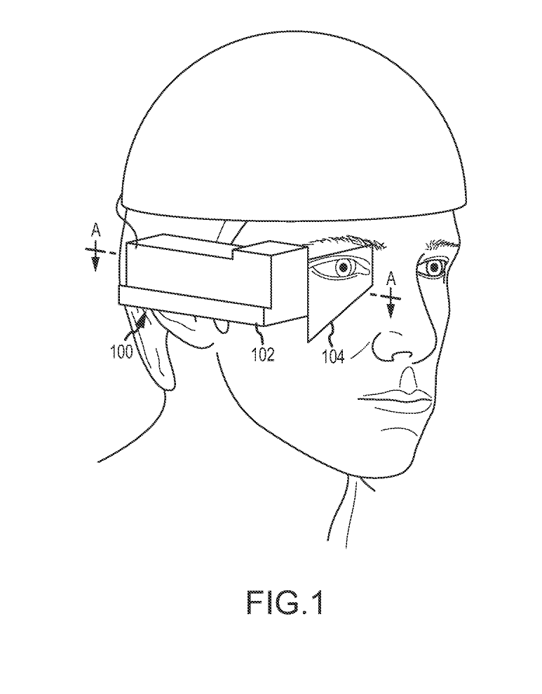

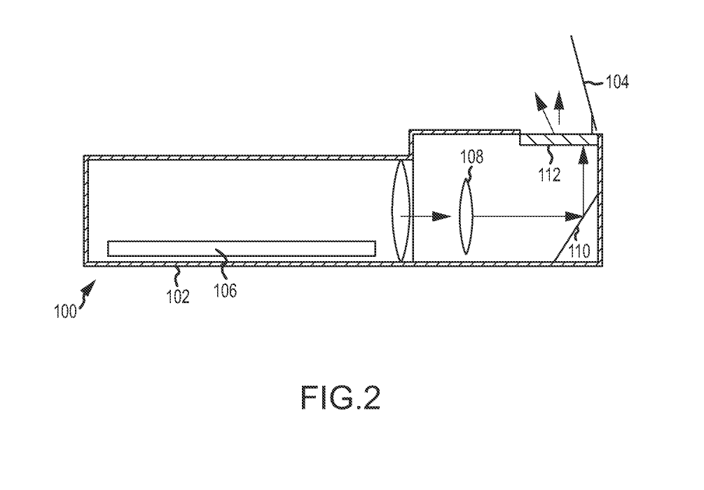

Referring to the drawings starting with FIG. 1, a display device 100 in which the present techniques may be implemented is illustrated. In particular, a heads-up display device 100 is illustrated. As may be appreciated, the heads-up display 100 may include a housing 102 and a viewing lens 104. FIG. 2 illustrates a cross-sectional view of the heads-up display device 100 including drive electronics 106 that may be enclosed within the housing 102, a first lens 108, a mirror 110 and a second lens 112. It should be appreciated, that in other embodiments, more or fewer component parts may be implemented. Moreover, other embodiments may take the form of other types of display devices such as television sets, computer monitors, projection systems, and so forth.

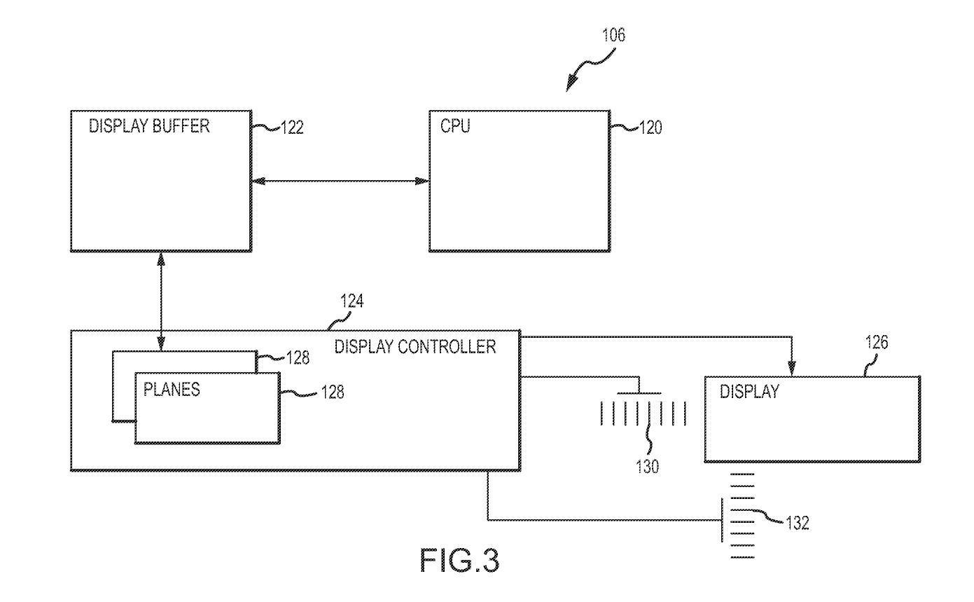

FIG. 3 illustrates a block diagram of the drive electronics 106 of the display device 100. The drive electronics 106 include a central processing unit (CPU) 120, a display buffer 122, a display controller 124, and a display 126. The display buffer may be a region of memory integral to or coupled with the CPU 120. Generally, the CPU 120 represents an image to the display 126 as an array of values in memory with each value representing the color of the pixel that is to be displayed. Although the memory of the display buffer 122 may be a linear array, an image is normally viewed as a 2 dimensional matrix in memory that is mapped by hardware to a 2 dimensional pixel matrix on the display 126. The display controller 124 may be integral to or separate from the CPU 120 but communicatively coupled thereto. The CPU 120 sends values from the display buffer 122 to the display controller 124 over a high speed bus. The display controller 124 then maps the image data to visible pixels on the display 126.

The resolution or number of pixels of the image in the display buffer 122 is higher than the resolution of the display 126 in terms of physical pixels. For example, the image in the display buffer 122 may be 640×320 pixels and the number of physical pixels on the display 126 may be 320×160. To display the high resolution image of the buffer 122 on the lower resolution display 126, the image in the display buffer 122 is split into memory buffers 128 referred to as planes within the display controller 124. Each plane 128 holds a down-sampled version of the high resolution image of the display buffer 122, such that the plane version matches the resolution of the display 126. For example, down-sampling a 640×320 image to a 320×160 image includes four planes 128 storing 320×160 pixels representing alternate rows and columns.

The display controller 124 refreshes the display 126 by cycling through the down-sampled planes 128 and activating actuators 130 and 132 that are coupled to display 126 to physically shift the display 126. The actuators 130 and 132 may include a horizontal actuator 130 and a vertical actuator 132. The actuators 130 and 132 control the horizontal and vertical displacement of the either the display and/or other optical components such as a lens, prism or mirror. The actuators 130 and 132 may be linear actuators and may take the form of any suitable actuator, such as a piezo element, magnetic actuator, or the like. The display 126 is shifted by the actuators at a rate that is too high to be detected by a human eye.

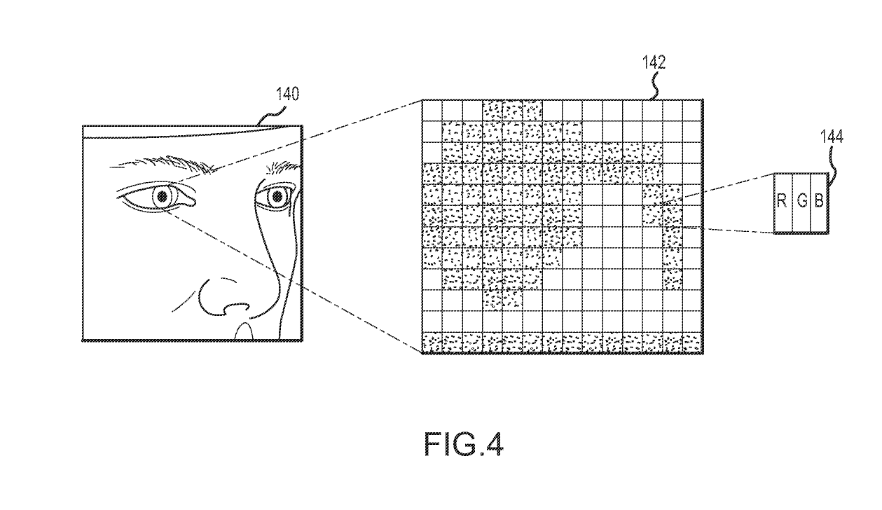

FIGS. 4-7 provide an example image and demonstrate a couple of different down-scaling and displaying schemes. Referring to FIG. 4, an image 140 is shown with a portion of the image progressively expanded so as to show individual pixels 142 arranged in a grid-like pattern and a single physical pixel 144 having red (R), green (G), and blue (B) light elements. As may be appreciated, the physical pixel 144 may be implemented as separate red, blue and green light sources or, alternatively, utilize a white light source with a color wheel or other appropriate light sources. Some embodiments may implement an incandescent light source, a light emitting diode, or other suitable light source. Furthermore, the techniques disclosed herein may be implemented in any suitable display technology, including light emitting diode (LED), organic LED, liquid crystal display (LCD), thin-film transistor (TFT) LCD, electronic ink (E-ink), phosphor based displays, and so forth. As such, technologies where the pixels themselves light up, where light is shone through pixels, where a mirror reflects light toward an eye, where colored dots rotate with black and white, where a phosphor is excited, and other display technologies may be implemented.

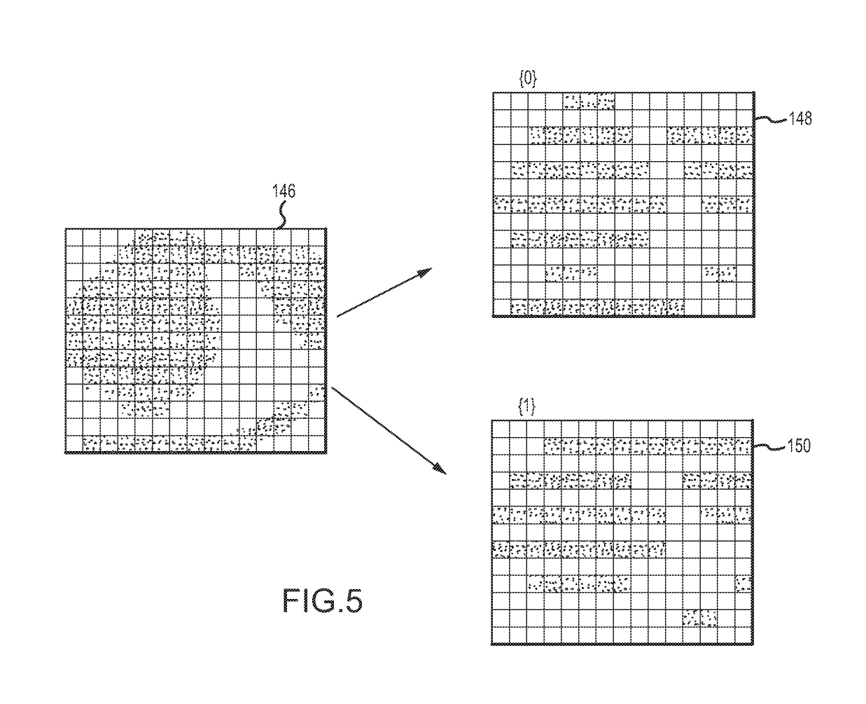

In relatively simple implementations, the effective resolution of the display 126 may be doubled by increasing either the vertical resolution or the horizontal resolution. In either case, the image 140 in the display buffer 122 may be separated into two planes consisting of alternating rows or columns. FIG. 5 illustrates a portion of the image 146 as it may appear in the display buffer 122 and after it has been divided vertically into separate planes 148 and 150. The first plane 148 may be displayed at a first position {0} during a first time period and the second plane 150 may be displayed at a second position {1} during a second time period. The first plane 148 includes all odd numbered rows and the second plane includes all even numbered rows. In this embodiment, a single actuator 132 may be implemented to displace the display vertically. It should be appreciated that the coordinates/positions {0} and {1} are arbitrarily selected and may be representative of a state of an actuator, rather than a relative position of a physical pixel. That is, the {0} may represent the actuator in a first position and {1} may represent the actuator in a second position, different from the first position. In some embodiments, the numbering may represent a coordinate system that includes both positive numbers and negative numbers based on a starting point within the coordinate system.

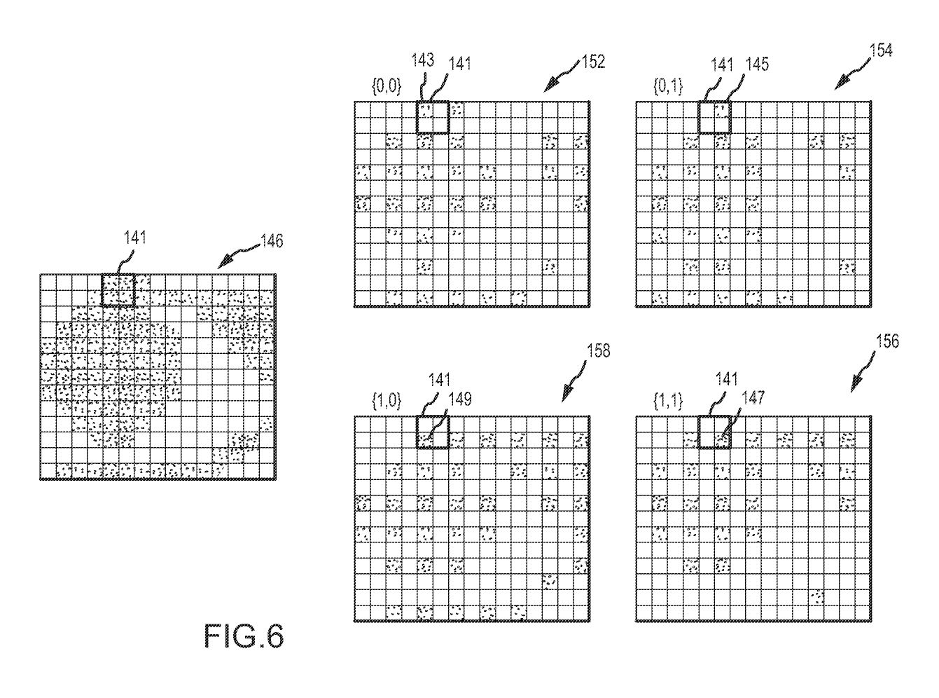

FIG. 6 illustrates the image 146 of the display buffer 122 being divided into four planes 152, 154, 156 and 158. The first plane 152 may be displayed at a first position {0,0} during a first time period, the second plane 154 at a second position {0, 1} during a second time period, the third plane 156 at a third position {1, 1} during a third time period, and the fourth plane at a fourth position {1, 0} during a fourth time period. In this embodiment, both actuators 130 and 132 may be used and each plane is mapped to particular actuator states.

To better understand the movement of a particular pixel, a meta-pixel 141 of the image 140 may be observed. Generally, in this embodiment, the meta-pixel 141 displays four pixels in a square pattern. Each of the four viewable pixels within the meta-pixel 141 may be provided by a single physical pixel that is shifted to display in each of the four positions of the four pixels. For example, in the first position {0, 0}, the physical pixel may be located in the top left corner 143 of the meta-pixel 141. In the second position {0, 1}, the physical pixel may be shifted to the top right corner 145 of the metal-pixel. The physical pixel may subsequently be shifted to a lower right corner 147 and then to a lower left corner 149 of the meta pixel 141 for the third and fourth positions. As such, a single physical pixel may have a unique position for each plane 152, 154, 156 and 158. Moreover, the physical pixel may move in a clock-wise manner, as shown, or in any other suitable manner.

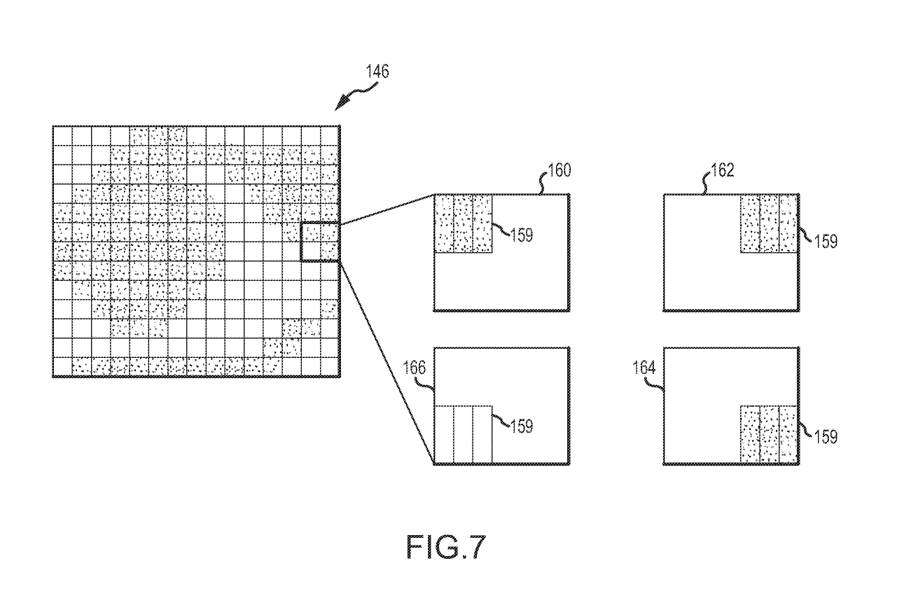

FIG. 7 illustrates an entire cycle for a single physical pixel 159 representing four pixels (e.g., a meta-pixel) of the image 146. The single physical pixel 159 is illustrated as including three illuminating elements, such as the aforementioned RGB light elements described above in FIG. 4. It should be appreciated that in practice the physical pixel may not be divided this way. Indeed, the physical pixel may include more or fewer illuminating elements. As may be seen, the four pixels of the image 146 are mapped to four different planes 160, 162, 164 and 166 and the physical pixel is positioned in a unique location within each of the planes based on a shift of the display 126. The display 126 may start with the physical pixel 159 in a first position 160, then shift to the right to the second position 162, then down for the third position 164 and finally to the left to the fourth position 166. Thus, one physical pixel 159 may serve as four pixels of the image 146.

The entire cycle from first through fourth positions 160-166 occurs at a rate greater than or equal to a refresh rate of the display 126. For example, if the refresh rate is 30 fps, the cycle has to complete at 240 Hz or greater, because of the Nyquist-Shannon sampling theorem. For a 1 cm square VGA display element, displacement would be approximately 0.001 to 0.002 cm. The display controller 124 may be responsible for synchronizing the pixel color change with the horizontal and/or vertical displacement of the display element. In this manner, a relatively inexpensive 640×480 VGA display could project an apparent resolution of 1280×960 or greater. The cost of the actuators and synchronization circuitry should generally be much less than the cost of physically representing the pixels independently, especially when the single physical pixel is scaled to represent four or more pixels.

It should be appreciated that the rate at which the pixel position changes (or oscillation rate) and even the pattern of the position change may vary responsive to image content. For example, if the image is a solid color, then the oscillation rate may be slowed down to save power. Similarly, the pattern in which the pixel is shifted may vary responsive to the update rate of the individual pixels in the image content.

The foregoing examples involved increasing the resolution by a factor of two in each dimension. In some embodiments, the resolution may be increased by factors greater than two. This is a matter of adding additional planes and actuator states. For example, increasing both the vertical and horizontal resolution by a factor of 3, the image 140 in the buffer 122 may be split into a total of nine planes and the actuators 130 and 132 would have nine states: {0, 0}, {0, 1}, {0, 2}, {1, 0}, {1, 1}, {1, 2}, {2, 0}, {2, 1}, and {2, 2}. In this example, an actuator position 0 may represent the actuator at rest, 1 may represent the actuator half extended, and 2 may represent the actuator fully extended. As such, the pixel may take one of three positions in a first direction (e.g., horizontal positions) and one of three positions in another direction (e.g., vertical positions). In some embodiments, a 3×3 square pattern may be formed by the shifted pixel. In other embodiments, a shape other than a square may be provided, such as a kite or diamond shape, for example. In still other embodiments, one or more positions may partially overlap with each other.

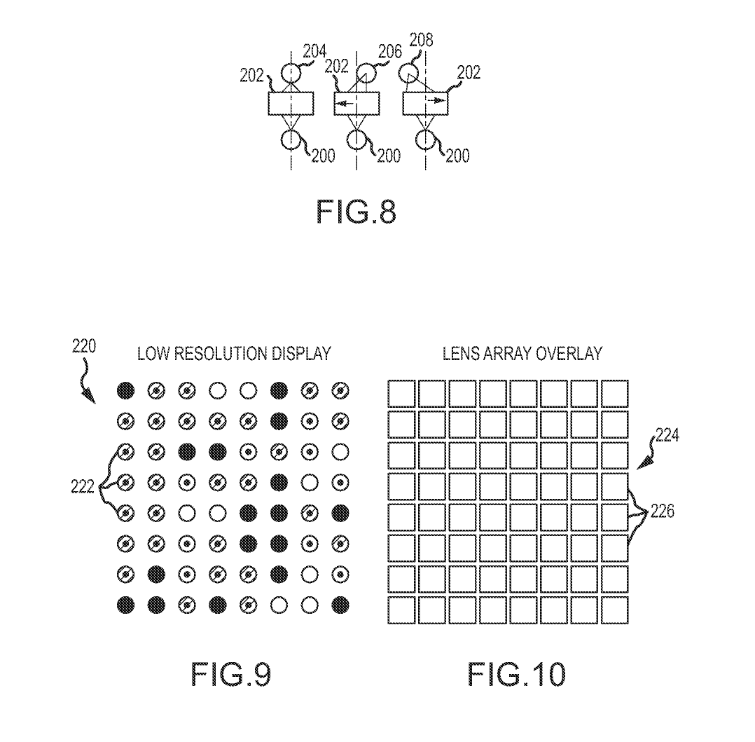

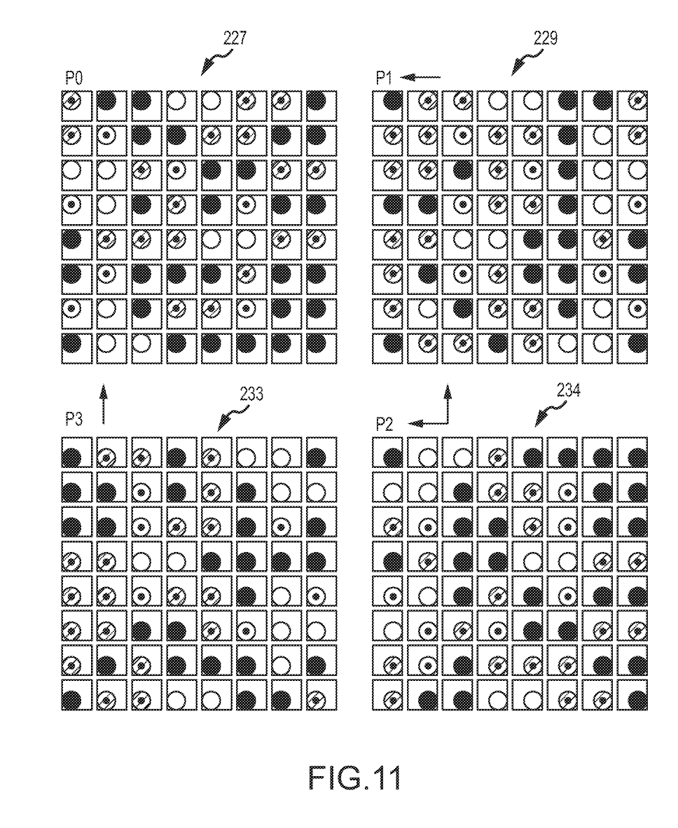

As mentioned above, other optical components in addition to the display 126 (e.g., light sources) may be actuated to achieve the desired pixel multiplication. In particular, for example, a lens or mirror may be tilted or displaced to achieve a shift in the location a pixel is displayed. FIG. 8 illustrates the optical principle that displacement of a lens results in a directionally opposite displacement of the location that pixel is displayed. As such, a physical pixel 200 transmitting light through a lens 202 may result in a first display location 204. Shifting the lens 202 to the left results in a second display location 206 to the right of the first display location 204 and shifting the lens 202 to the right results in a third display location 208 to the left of the first display location.

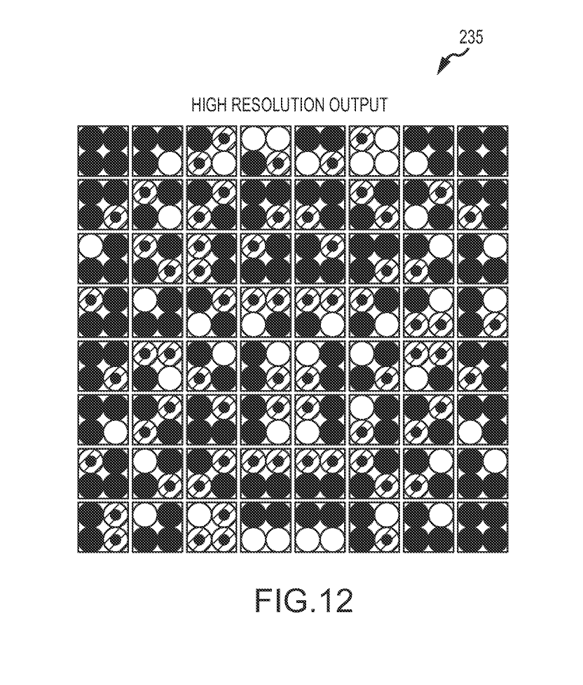

FIG. 9 illustrates an example low resolution display 220 having a low pixel density (e.g., relatively few physical pixels 222). A lens array 224, as shown in FIG. 10, may overlay the low resolution display 220 to help facilitate the pixel multiplication technique described herein. The lens array 224 may have a one-to-one correlation of lenses 226 to pixels 222 of the display 220. As the low resolution display cycles through planes having image pixel data, as discussed above, the lens array 224 is shifted to give the appearance of multiple pixels per physical pixel 222 of the low resolution display 220. In this embodiment, unlike the one described above, the lenses may be shifted/moved by one or more actuators while the display elements (e.g., the pixels) remain stationary. Thus, as the lenses change their position, the light from an underlying pixel may be angled and/or refocused such that the pixel appears to occupy a different physical position to an observer, although the pixel in fact remains stationary. That is, as the low resolution display cycles through planes having image pixel data, as discussed above, the lens array 224 is shifted to give the appearance of multiple pixels per physical pixel 222 of the low resolution display 220. In particular, displayed pixels may start in a first position 227 shown in P0 and the lens may shift to the left to move the display location to a second position 229 shown in P1 (to the right of first position P0), shift up to move the display location to a third position 231 shown in P2 (downward from the second position P1), shift to the right to mover the display location to a fourth position 233 shown in P3 (to the left of the third position P2) and shift down to return to the first position 227 (upward from the fourth position P3). Thus, a high resolution image 235 may be displayed, as shown in FIG. 12, which effectively displays an image with four times the pixel density of the physical pixels 222 shown in FIG. 9.

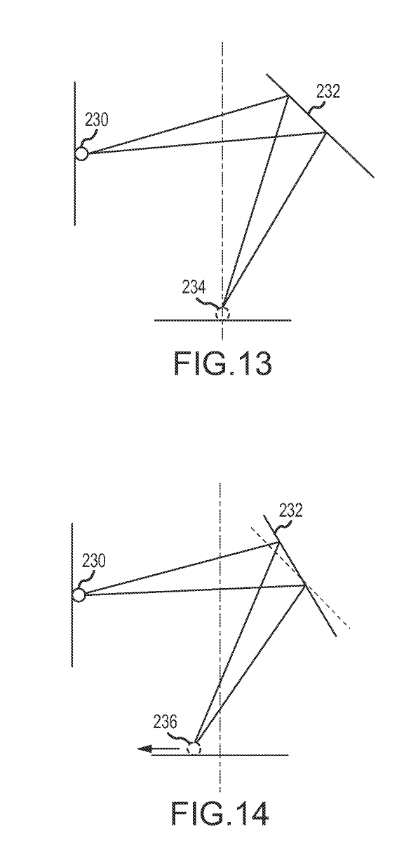

Similarly, a mirror may be actuated in a manner to move the display location of the pixels. As shown in FIG. 13, a physical pixel 230 may be reflected off a mirror 232 to display in a first location 234. The mirror 232 may be tilted by an actuator (FIG. 14) to shift the location that the pixel is displayed 236.

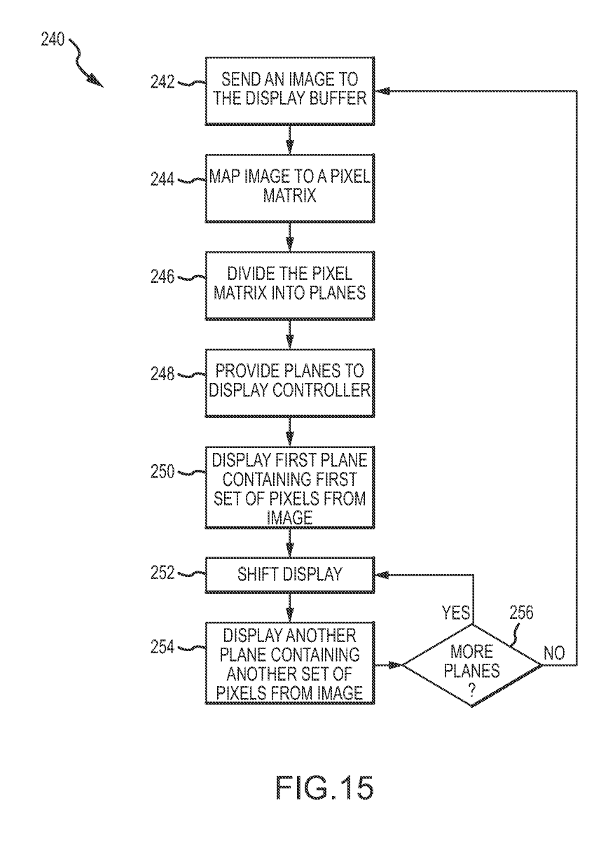

FIG. 15 is a flow chart illustrating a method 240 of increasing resolution through mechanical actuation in accordance with an example embodiment. Initially, an image is sent to the display buffer (Block 242). The image is mapped to a pixel matrix (Block 244). The pixel matrix is divided into planes (Block 246). The number of planes generally corresponds to the number of positions which a display may be shifted. The planes may provided to a display controller (Block 248) and sequentially provided for display. That is a first plane is displayed containing a first set of pixels (Block 250), the display is shifted (Block 252) and another plane containing another set of pixels is displayed (Block 254). It is then determined if there are more planes (Block 256). If there are, the display is shifted (Block 252) and another plane is displayed (Block 256). If there are no more planes, the method 240 restarts with sending another image to the display buffer (Block 242).

The foregoing discussion describes some example systems and methods to increase resolution through mechanical actuation. Although the foregoing discussion has presented specific embodiments, persons skilled in the art will recognize that changes may be made in form and detail without departing from the spirit and scope of the embodiments. For example, in some embodiments, one or more actuators may be coupled to more than one component to enable the pixel multiplication. In particular, in some embodiments, actuators may be coupled to the display 126 to enable to enable vertical and/or horizontal shifts, while an actuator coupled to a lens array may be actuated to facilitate diagonal pixel shifts. In still another embodiment, mirrors and lenses may be actuated in combination to multiply the pixels. In each embodiment, the pixels of the images are divided into planes that are cyclically displayed by the physical pixels. Accordingly, the specific embodiments described herein should be understood as examples and not limiting the scope thereof.

1. A display device comprising:
a processor configured to read an image for display;
a memory coupled to the processor configured to store the image and to map the image to a pixel matrix;
a display controller coupled to the memory, the controller configured to sample portions of the image and store the portions of the image into planes, wherein each sampled portion comprises a different set of pixels of the pixel matrix;
a display coupled to the controller, the display configured to display the contents of the sampled planes, wherein the display controller is configured to sequentially provide the sampled planes to the display; and
at least one actuator coupled to the display to displace the display so that the contents of each plane are displayed in a unique position relative to the contents of the other planes.

2. The display device of claim 1, wherein the display comprises a liquid crystal display.

3. The display device of claim 1, wherein the display comprises a light emitting diode display.

4. The display device of claim 1, wherein the at least one actuator comprises at least one piezo element.

5. The display device of claim 1, wherein the at least one actuator comprises at least one magnetic element.

6. The display device of claim 1, wherein the display controller actuates the at least one actuator.

7. The display device of claim 1, wherein the at least one actuator comprises a first actuator configured to displace the display in a first direction, and a second actuator configured to displace the display in a second direction generally different from the first direction.

8. The display device of claim 1 further comprising at least one lens through which light emitted from the display passes.

9. The display device of claim 8 further comprising at least one actuator coupled to the lens and configured to shift the lens to displace the location of the contents of the planes.

10. The display device of claim 1 further comprising at least one mirror configured to reflect light emitted from the display.

11. The display device of claim 10 further comprising at least one actuator coupled to the mirror and configured to displace the mirror to alter the location of the content of the planes.

12. A method of increasing resolution through mechanical actuation comprising:
sending, by a processor, an image to a memory buffer;
mapping the image to a pixel matrix;
dividing the pixel matrix with the image into multiple planes, wherein each plane comprises a different set of pixels of the image;
sequentially displaying the planes with their respective set of pixels; and
shifting the display with an actuator so that pixels of each plane display in a unique location.

13. The method of claim 12, wherein the pixel matrix is divided into four planes.

14. The method of claim 12, wherein the method is configured to multiply an effective pixel density by a factor of at least two.

15. The method of claim 12, wherein shifting the display comprises shifting the display in a first direction for display of pixels of a first plane and in a second direction for display of pixels of a second plane.

16. The method of claim 12 further comprising shifting a lens through which light from the display passes.

17. The method of claim 12 further comprising displacing a mirror which reflects light from the display.

18. A display device comprising:
a processor configured to read in an image having a first resolution;
a memory buffer coupled to the processor and configured to receive the image;
a display controller coupled to the memory buffer, the display controller configured to sample a first portion of the image and save the first portion of the image into a first plane, and sample a second portion of the image and save the second portion of the image into a second plane wherein the first portion and the second portion comprise different portions of the image;
a display coupled to the display controller, the display comprising a number of physical pixels which corresponds to a number of pixels in the first and second portions of the image; and
an actuator coupled to the display, wherein the display is configured to sequentially display the pixels of the first plane and the second plane, wherein further the actuator is configured to displace the display after display of the pixels of the first plane so that the pixels of the second plane are displayed in a second position.

19. The display device of claim 18 further comprising:
a lens through which light from the display passes; and
a mirror configured to reflect light from the display for viewing.

20. The display device of claim 20 comprising a heads-up display.
